(19) United States
(12) Patent Application Publication
(10) Pub. No.: US 2024/0008501 A1
(43) Pub. Date: Jan. 11, 2024

(54) EDIBLE COATING COMPOSITIONS

(71) Applicant: Apeel Technology, Inc., Goleta, CA (US)

(72) Inventors: David Fisher, Goleta, CA (US); Daniel Essert, Goleta, CA (US)

(21) Appl. No.: 18/218,944

(22) Filed: Jul. 6, 2023

Related U.S. Application Data
(60) Provisional application No. 63/358,730, filed on Jul. 6, 2022.

(51) Int. Cl. A23B 7/16; A23L 3/3517; A23L 3/3553; A23L 3/358; A23B 7/154; A23B 7/157

(52) U.S. Cl. CPC A23B 7/16; A23L 3/3517; A23L 3/3553; A23L 3/358; A23B 7/154; A23B 7/157

(57) ABSTRACT

Compositions and coating mixtures for coating agricultural and other consumable products, and methods of preparing the compositions and coating mixtures.

### CROSS REFERENCE TO RELATED APPLICATION

This application claims the benefit of U.S. Application No. 63/358,730, filed on Jul. 6, 2022, which is incorporated by reference herein in its entirety.

### TECHNICAL FIELD

This document discloses compositions and coating mixtures for coating agricultural and other consumable products, and methods of preparing the compositions and coating mixtures.

### BACKGROUND

Common agricultural products are susceptible to degradation and decomposition (i.e., spoilage) when exposed to the environment. Such agricultural products can include, for example, eggs, fruits, vegetables, produce, seeds, nuts, flowers, and/or whole plants (including their processed and semi-processed forms). Non-agricultural products (e.g., vitamins, candy, etc.) are also vulnerable to degradation when exposed to the ambient environment.

Conventional approaches to preventing degradation, maintaining quality, and increasing the life of agricultural products include special packaging and/or refrigeration. Refrigeration requires capital-intensive equipment, demands constant energy expenditure, can cause damage or quality loss to the product if not carefully controlled, must be actively managed, and its benefits are lost upon interruption of a temperature-controlled supply chain. Produce mass loss (e.g., water loss) during storage increases humidity, which necessitates careful maintenance of relative humidity levels (e.g., using condensers) to avoid negative impacts (e.g., condensation, microbial proliferation, etc.) during storage. Moreover, respiration of agricultural products is an exothermic process which releases heat into the surrounding atmosphere. During transit and storage in shipping containers, heat generated by the respiration of the agricultural product, as well as external environmental conditions and heat generated from mechanical processes (e.g., motors) necessitates active cooling of the storage container in order to maintain the appropriate temperature for storage, which is a major cost driver for shipping companies. By reducing the rate of degradation, reducing the heat generation in storage and transit, and increasing the shelf life of agricultural products, there is a direct value to the key stakeholders throughout the supply chain.

### SUMMARY

Provided herein are edible coating compositions including a coating mixture, a base, and a solvent. In some embodiments, the coating mixture includes about 75 wt % to about 98 wt % of one or more monoglycerides; about 1 wt % to about 5 wt % of one or more fatty acid salts; and about 1 wt % to about 20 wt % of one or more of lecithin, an ammonium phosphatide, and lysolecithin.

Also provided herein are agricultural products having a coating thereover, wherein the coating is formed from the edible coating composition of the disclosure.

Also provided herein are methods of preparing an edible coating composition of the disclosure, the method comprising: combining a solvent and a base to yield a first mixture; and combining the first mixture and a coating mixture to yield the edible coating composition of the disclosure, wherein the coating mixture comprises: about 75 wt % to about 98 wt % of one or more monoglycerides; about 1 wt % to about 5 wt % of one or more fatty acid salts; and about 1 wt % to about 20 wt % of one or more of lecithin, an ammonium phosphatide, and lysolecithin.

Also provided herein are methods of coating an agricultural product, the method comprising: applying the edible coating composition of the disclosure to a surface of an agricultural product; and drying the edible coating composition of the disclosure on the surface of the agricultural product.

Also provided herein are edible coating compositions for coating an agricultural product, wherein the edible coating composition of the disclosure is prepared according to the disclosure.

There is a need for new, more cost-effective approaches to prevent degradation, reduce the generation of heat and humidity, maintain quality, and increase the life of agricultural products. Embodiments of the edible coating compositions described herein can provide one or more advantages. For example, in some embodiments, the edible coating compositions can protect the agricultural products from biotic stressors (e.g., bacteria, viruses, fungi, or pests). The edible coating compositions can also inhibit or prevent evaporation of water and/or diffusion of oxygen, carbon dioxide, and/or ethylene. The edible coating compositions can also help extend the shelf life of agricultural products (e.g., post-harvest produce) without refrigeration. The edible coating compositions can reduce the average mass loss rate for the coated agricultural products. The edible coating compositions can also introduce mechanical stability to the surface of the agricultural products eliminating the need for expensive packaging designed to prevent the types of bruising that accelerates spoilage. The edible coating compositions can also be naturally derived, and hence, safe for human consumption. The edible coating compositions can also include one or more of lecithin, lysolecithin, and an ammonium phosphatide that are more economical and sustainable than other emulsifiers.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF THE DRAWINGS

FIG. 1 shows differential scanning calorimetry (DSC) traces of two coating composition examples.

FIG. 2 shows viscosity versus shear rate for three coating composition examples.

### DETAILED DESCRIPTION

The edible coating compositions disclosed herein are useful for coatings of agricultural products. In some embodiments, the edible coating compositions include a coating mixture, a base, and a solvent. In some embodiments, the coating mixture includes one or more monoglycerides, one or more fatty acid salts, and one or more of lecithin, an ammonium phosphatide, and lysolecithin.

### Definitions

For the disclosure to be more readily understood, certain terms are first defined. These definitions should be read in light of the remainder of the disclosure as understood by a person of ordinary skill in the art. Additional definitions are set forth throughout the detailed description.

As used herein, the term “lecithin” refers to phosphatidylcholine or 1,2-diacyl-glycero-3-phosphocholine. Lecithin, as used herein, can additionally be part of a lecithin mixture which is a natural mixture of neutral and polar lipids (e.g., glycerophospholipids) such as, for example, phosphatidylcholine, phosphatidylethanolamine, phosphatidylinositol, phosphatidylserine, and phosphatidic acid. Phosphatidylcholine can be present in the lecithin mixture in concentrations of about 20 wt % to about 90 wt %. The fatty acids residues of phosphatidylcholine may be saturated, mono-unsaturated or poly-unsaturated. The lecithin and the lecithin mixture can be provided as an oil solution or a de-oiled solution or powder. The lecithin or lecithin mixture in an oil solution includes about 25 wt % to 50 wt % oil. The de-oiled solution includes about 1 wt % to 10 wt % oil or about 5 wt % to 10 wt % oil.

As used herein, the term “lysolecithin” refers to lysophosphatidylcholine. Lysolecithin, as used herein, can additionally be part of a lysolecithin mixture, which is a natural mixture of neutral and polar lipids (e.g., lysophospholipids) such as, for example, lysophosphatidylcholine, lysophosphatidylethanolamine, lysophosphatidylinositol, lysophosphatidylserine and lysophosphatidylglycerol.

As used herein, the term “ammonium phosphatide” refers to one or more ammonium neutralized phosphoric esters of monoglycerides and diglycerides.

As used herein, a monoglyceride having a carbon chain length of, for example, about C10 to about C22, refers to the lipophilic portion of the monoglyceride having about 10 carbon atoms to about 22 carbon atoms. For example, a C18 monoglyceride would include glyceryl monostearate because the lipophilic portion of the molecule (e.g., monostearate) has a carbon chain length of 18 carbon atoms, e.g., (C₁₈H₃₅O)—.

As used herein, “glyceryl” refers to a propyl radical substituted with a hydroxyl at each of the two carbon atoms that the radical is not centered on. In some embodiments, a glyceryl is 1-glyceryl (i.e., —CH₂CH(OH)CH₂OH). In some embodiments, a glyceryl is 2-glyceryl (i.e., —CH(CH₂OH)CH₂OH).

As used herein, “fatty acid derivative” is a hydrocarbon chain comprising an ester, acid, or carboxylate group, collectively referred to as “oxycarbonyl moieties”, bonded to one terminus of the hydrocarbon chain, understood to be the “hydrophilic” end; while the opposite terminus is understood to be the “hydrophobic” end. Fatty acid derivatives include fatty acids, fatty acid esters (e.g., monoglycerides), and fatty acid salts.

As used herein, the term “mass loss rate” refers to the rate at which the product loses mass (e.g., by releasing water and other volatile compounds). The mass loss rate is typically expressed as a percentage of the original mass per unit time (e.g., percent per day).

As used herein, the term “mass loss factor” is defined as the ratio of the average mass loss rate of uncoated produce (measured for an untreated control group) to the average mass loss rate of the corresponding tested produce (e.g., coated produce) over a given time. Hence a larger mass loss factor for a coated produce corresponds to a greater reduction in average mass loss rate for the coated produce.

In some embodiments, the edible coating composition is coated onto an agricultural product. When the edible coating composition is coated onto an agricultural product, the edible coating composition increases the mass loss factor of the agricultural product. In some examples, an agricultural product that is not coated by the edible coating composition has a mass loss factor of 1, while agricultural products that are coated by the edible coating composition have a mass loss factor of at least 1.5, or at least 1.55, or at least 1.6, or at least 1.7, or at least 1.75, or at least 1.8. Advantageously, the edible coating composition increases the mass loss factor of the agricultural product.

As used herein, the term “error propagation” is defined as the effects on a function by a variable's uncertainty. Error propagation is a calculus derived statistical calculation designed to combine uncertainties from multiple variables to provide a measurement of uncertainty, e.g., as used in the following reference: Kirchner, James. “Data Analysis Toolkit #5: Uncertainty Analysis and Error Propagation”. Berkeley Seismology Laboratory. University of California, Retrieved 22 Apr. 2016.

Throughout this specification and embodiments, the word “comprise,” or variations such as “comprises” or “comprising,” will be understood to imply the inclusion of a stated integer or group of integers but not the exclusion of any other integer or group of integers.

The term “including” or “includes” is used to mean “including but not limited to.” “Including” and “including but not limited to” are used interchangeably.

Any example(s) following the term “e.g.” or “for example” is not meant to be exhaustive or limiting.

Unless otherwise required by context, singular terms shall include pluralities and plural terms shall include the singular.

The articles “a”, “an”, and “the” are used herein to refer to one or to more than one (i.e., to at least one) of the grammatical object of the article.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g., 1 to 6.1, and ending with a maximum value of 10 or less, e.g., 5.5 to 10.

When the terms “about” and “at least” precede a numeral, these terms also apply to any following numeral or range. For example, “about 1, 2, or 3” means “about 1, about 2, or about 3” and “about 1 to 10, 10 to 20, or 20 to 30” means “about 1 to about 10, about 10 to about 20, or about 20 to about 30.” “At least” is used in the same way.

Unless otherwise defined herein, scientific and technical terms used in this application have the meanings that are commonly understood by those of ordinary skill in the art. In case of conflict, the present specification, including definitions, will control.

Each embodiment of this disclosure may be taken alone or in combination with one or more other embodiments of this disclosure.

Exemplary methods and materials are described herein. Methods and materials similar or equivalent to those described herein can also be used in the practice or testing of the various aspects and embodiments. The materials, methods, and examples are illustrative only and not intended to be limiting.

### Coating Mixture

In one aspect, the coating mixture includes one or more monoglycerides, one or more fatty acid salts, and one or more of lecithin, an ammonium phosphatide, and lysolecithin.

In some embodiments, the coating mixture includes one or more monoglycerides. In some embodiments, the coating mixture includes one monoglyceride (e.g., a 1-monoglyceride or a 2-monoglyceride). In some embodiments, the coating mixture includes two monoglycerides (e.g., two 1-monoglycerides, two 2-monoglycerides, or one 1-monoglyceride and one 2-monoglyceride). In some embodiments, the coating mixture includes three monoglycerides. In some embodiments, the coating mixture includes four or more monoglycerides.

In some embodiments, the monoglyceride has a carbon chain length of about C10 to about C22. In some embodiments, the monoglyceride has a carbon chain length that comprises one or more of or is selected from the group consisting of a C10 monoglyceride, a C12 monoglyceride, a C14 monoglyceride, a C16 monoglyceride, a C18 monoglyceride, a C20 monoglyceride, a C22 monoglyceride, and a combination thereof. In some embodiments, the monoglyceride is a saturated monoglyceride. In some embodiments, the saturated monoglyceride is monolaurin, glyceryl monostearate, glycerol monostearate, or glyceryl hydroxystearate. In some embodiments, the monoglyceride is glyceryl monostearate. In some embodiments, the monoglyceride is glycerol monostearate.

In some embodiments, the one or more monoglycerides is present in the coating mixture in an amount in a range of about 40 wt % to about 99 wt %, based on the total weight of the coating mixture. For example, the one or more monoglycerides is present in the coating mixture in an amount in a range of about 60 wt % to about 99 wt %, about 70 wt % to about 98 wt %, about 85 wt % to about 98 wt %, about 90 wt % to about 98 wt %, about 92 wt % to about 97 wt %, or about 95 wt %. In some embodiments, the one or more monoglycerides is present in the coating mixture in an amount in a range of about 75 wt % to about 98 wt %.

In some embodiments, the coating mixture includes one or more fatty acid salts. In some embodiments, the coating mixture includes one fatty acid salt. In some embodiments, the coating mixture includes two fatty acid salts. In some embodiments, the coating mixture includes three fatty acid salts. In some embodiments, the coating mixture includes four or more fatty acid salts.

In some embodiments, at least one of the one or more fatty acid salts comprises a carbon chain length of about C10 to about C20. In some embodiments, each of the one or more fatty acid salts comprises a carbon chain length of about C10 to about C20. In some embodiments, at least one of the one or more fatty acid salts comprises a carbon chain length selected from the group of: C10, C12, C14, C16, C18, or C20. In some embodiments, each of the one or more fatty acid salts comprises a carbon chain length selected from the group of: C10, C12, C14, C16, C18, or C20. In some embodiments, the one or more fatty acid salts is a C14 fatty acid salt, C16 fatty acid salt, a C18 fatty acid salt, or a combination thereof. In some embodiments, the one or more fatty acid salts is a C16 fatty acid salt, and a C18 fatty acid salt. In some embodiments, one or more of the fatty acid salts is saturated. In some embodiments, one or more of the fatty acid salts is unsaturated.

In some embodiments, one or more of the fatty acid salts is a salt of lauric acid, myristic acid, palmitic acid, stearic acid, archidic acid, behenic acid, lignoceric acid, palmitoleic acid, caprylic acid, capric acid, cerotic acid, oleic acid, linoleic acid, arachidonic acid, eicosapentaenoic acid, docosahexaenoic acid, myristoleic acid, sapienic acid, elaidic acid, vaccenic acid, linoelaidic acid, α-linolenic acid, erucic acid, docosahexaenoic acid, or combinations thereof.

In some embodiments, the fatty acid is a fatty acid salt. In some embodiments the fatty acid salt comprises one or more of or is selected from the group consisting of sodium laurate, sodium myristate, sodium palmitate, sodium stearate, archidic acid salt, sodium behenate, lignoceric acid sodium salt, sodium arachidonate, eicosapentaenoic acid sodium salt, docosahexaenoic acid sodium salt, sodium myristate, sapienate, elaidate, linoleic acid sodium salt, linoleic acid sodium salt, sodium erucate, docosahexaenoic acid sodium salt, or combinations thereof.

In some embodiments, the one or more fatty acid salts is present in the coating mixture in an amount in a range of about 1 wt % to about 20 wt %, based on the total weight of the coating mixture. For example, the one or more fatty acid salts is present in the coating mixture in an amount in a range of about 1 wt % to about 10 wt %, about 1 wt % to about 8 wt %, 1 wt % to about 5 wt %, or about 1 wt % to about 3 wt %. In some embodiments, the one or more fatty acid salts is present in the coating mixture in an amount in a range of about 1 wt % to about 5 wt %.

In some embodiments, the coating mixture includes an emulsifier. Emulsifiers, a type of surfactants, are excipients used for lowering the surface tension and for interaction with hydrophobic materials. Lecithin and lysolecithin are natural emulsifiers present in most of the plant and animal tissues as an important structural component of cell membranes. Lecithin and lysolecithin have emulsifying, surfactant and lubricant properties.

In some embodiments, the coating mixture includes one or more of lecithin, an ammonium phosphatide, and lysolecithin. In some embodiments, the coating mixture includes lecithin. In some embodiments, the coating mixture includes an ammonium phosphatide. In some embodiments, the coating mixture includes lysolecithin. In some embodiments, the coating mixture includes lecithin and lysolecithin. In some embodiments, the coating mixture includes lecithin, lysolecithin, and an ammonium phosphatide. In some embodiments, the coating mixture includes lysolecithin and an ammonium phosphatide. In some embodiments, the coating mixture includes lecithin and an ammonium phosphatide.

In some embodiments, the one or more of lecithin, an ammonium phosphatide, and lysolecithin is present in the coating mixture in an amount in a range of about 1 wt % to about 25 wt %, based on the total weight of the coating mixture. For example, the one or more of lecithin, an ammonium phosphatide, and lysolecithin are present in the coating mixture in an amount in a range of about 1 wt % to about 20 wt %, about 1 wt % to about 15 wt %, 1 wt % to about 12 wt %, about 1 wt % to about 10 wt %, or about 3 wt % to about 8 wt %. In some embodiments, the one or more of lecithin, an ammonium phosphatide, and lysolecithin are present in the coating mixture in an amount in a range of about 1 wt % to about 20 wt %. In some embodiments, the one or more of lecithin, an ammonium phosphatide, and lysolecithin are present in the coating mixture in an amount in a range of about 1 wt % to about 15 wt %.

In some embodiments, the coating mixture includes about 70 wt % to about 98 wt % of one or more monoglycerides and about 1 wt % to about 15 wt % of one or more of lecithin, an ammonium phosphatide, and lysolecithin. In some embodiments, the coating mixture includes about 75 wt % to about 98 wt % of one or more monoglycerides and about 1 wt % to about 12 wt % of one or more of lecithin, an ammonium phosphatide, and lysolecithin.

For example, a coating mixture can include about 70 wt % to about 98 wt % of a C10 monoglyceride, a C12 monoglyceride, a C14 monoglyceride, a C16 monoglyceride, a C18 monoglyceride, a C20 monoglyceride, a C22 monoglyceride, and combinations thereof and about 1 wt % to about 15 wt % of one or more of lecithin, an ammonium phosphatide, and lysolecithin.

In some embodiments, the coating mixture includes about 70 wt % to about 98 wt % of one or more monoglycerides; about 1 wt % to about 10 wt % of one or more fatty acid salts; and about 1 wt % to about 20 wt % of one or more of lecithin, an ammonium phosphatide, and lysolecithin.

For example, a coating mixture can include about 70 wt % to about 98 wt % of a C10 monoglyceride, a C12 monoglyceride, a C14 monoglyceride, a C16 monoglyceride, a C18 monoglyceride, a C20 monoglyceride, a C22 monoglyceride, and combinations thereof; about 1 wt % to about 10 wt % of a C14 fatty acid salt, C16 fatty acid salt, a C18 fatty acid salt, and combinations thereof; and about 1 wt % to about 15 wt % of one or more of lecithin, an ammonium phosphatide, and lysolecithin. In some embodiments, the coating mixture includes about 70 wt % to about 98 wt % of a C10 monoglyceride, a C12 monoglyceride, a C14 monoglyceride, a C16 monoglyceride, a C18 monoglyceride, a C20 monoglyceride, a C22 monoglyceride, and combinations thereof, about 1 wt % to about 10 wt % of a C14 fatty acid salt, C16 fatty acid salt, a C18 fatty acid salt, and combinations thereof, and about 1 wt % to about 15 wt % of lecithin. In some embodiments, the coating mixture includes about 70 wt % to about 98 wt % of a C10 monoglyceride, a C12 monoglyceride, a C14 monoglyceride, a C16 monoglyceride, a C18 monoglyceride, a C20 monoglyceride, a C22 monoglyceride, and combinations thereof, about 1 wt % to about 10 wt % of a C14 fatty acid salt, a C16 fatty acid salt, a C18 fatty acid salt, and combinations thereof, and about 1 wt % to about 15 wt % of an ammonium phosphatide. In some embodiments, the coating mixture includes about 70 wt % to about 98 wt % of a C10 monoglyceride, a C12 monoglyceride, a C14 monoglyceride, a C16 monoglyceride, a C18 monoglyceride, a C20 monoglyceride, a C22 monoglyceride, and combinations thereof, about 1 wt % to about 10 wt % of a C14 fatty acid salt, C16 fatty acid salt, a C18 fatty acid salt, and combinations thereof; and about 1 wt % to about 15 wt % of lysolecithin.

In some embodiments, the one or more monoglycerides are saturated monoglycerides. In some embodiments, the saturated monoglycerides include one or more of monolaurin, glyceryl monostearate, glycerol monostearate, and glyceryl hydroxystearate. In some embodiments, the one or more fatty acid salts are saturated fatty acid salts. In some embodiments, the saturated fatty acid salts include one or more of sodium laurate, sodium myristate, sodium palmitate, sodium stearate, and sodium behenate. In some embodiments, the one or more monoglycerides are saturated monoglycerides and the one or more fatty acid salts are saturated fatty acid salts.

In some embodiments, the coating mixture includes about 80 wt % to about 98 wt % of one or more of monolaurin, glyceryl monostearate, glycerol monostearate, and glyceryl hydroxystearate, and about 1 wt % to about 15 wt % lecithin. In some embodiments, the coating mixture includes about 80 wt % to about 98 wt % of one or more of monolaurin, glyceryl monostearate, glycerol monostearate, and glyceryl hydroxystearate, and about 1 wt % to about 15 wt % lysolecithin. In some embodiments, the coating mixture includes about 80 wt % to about 98 wt % of one or more of monolaurin, glyceryl monostearate, glycerol monostearate, and glyceryl hydroxystearate, and about 1 wt % to about 15 wt % ammonium phosphatide.

In some embodiments, the coating mixture includes about 80 wt % to about 98 wt % of one or more of monolaurin, glyceryl monostearate, glycerol monostearate, and glyceryl hydroxystearate; about 1 wt % to about 10 wt % of one or more of sodium laurate, sodium myristate, sodium palmitate, sodium stearate, and sodium behenate; and about 1 wt % to about 15 wt % lecithin. In some embodiments, the coating mixture includes about 80 wt % to about 98 wt % of one or more of monolaurin, glyceryl monostearate, glycerol monostearate, and glyceryl hydroxystearate; about 1 wt % to about 10 wt % of one or more of sodium laurate, sodium myristate, sodium palmitate, sodium stearate, and sodium behenate; and about 1 wt % to about 15 wt % lysolecithin. In some embodiments, the coating mixture includes about 80 wt % to about 98 wt % one or more of monolaurin, glyceryl monostearate, glycerol monostearate, and glyceryl hydroxystearate; about 1 wt % to about 10 wt % of one or more of sodium laurate, sodium myristate, sodium palmitate, sodium stearate, and sodium behenate; and about 1 wt % to about 15 wt % ammonium phosphatide.

In some embodiments, the coating mixture includes about 80 wt % to about 98 wt % glyceryl monostearate; about 1 wt % to about 10 wt % sodium stearate; and about 1 wt % to about 15 wt % lecithin. In some embodiments, the coating mixture includes about 80 wt % to about 98 wt % glyceryl monostearate; about 1 wt % to about 10 wt % sodium stearate; and about 1 wt % to about 15 wt % lysolecithin. In some embodiments, the coating mixture includes about 80 wt % to about 98 wt % glyceryl monostearate; about 1 wt % to about 10 wt % sodium stearate; and about 1 wt % to about 15 wt % ammonium phosphatide.

### Edible Coating Composition

Edible coating compositions and/or coating mixtures formed from or containing a high percentage of monoglycerides in combination with one or more of lecithin, lysolecithin, and ammonium phosphatide have been found to be effective at forming protective coatings over a variety of substrates that can prevent water loss from and oxidation of the substrate. The addition of a base can further improve the performance thereof. Accordingly, the compositions and coating mixtures herein can include one or more of monolaurin, glyceryl monostearate, glycerol monostearate, and glyceryl hydroxystearate as well as one or more of lecithin, lysolecithin, and ammonium phosphatide.

In some embodiments, less than 10% (e.g., less than 5%, less than 2%, less than 1%) by weight of the composition is diglycerides. In some embodiments, less than 10% (e.g., less than 5%, less than 2%, less than 1%) by weight of the composition is triglycerides. In some embodiments, the composition does not comprise an acetylated monoglyceride (e.g., a monoglyceride wherein the hydroxyl groups of the glyceryl moiety are acetylated).

In some embodiments, the coating mixture can be dissolved, mixed, dispersed, or suspended in a solvent to form a composition (e.g., solution, suspension, or colloid). Examples of solvents that can be used include water, methanol, ethanol, isopropanol, butanol, acetone, ethyl acetate, chloroform, acetonitrile, tetrahydrofuran, diethyl ether, methyl tert-butyl ether, or combinations thereof. For example, the solvent is water. For example, the solvent is ethanol.

In some embodiments, the concentration of the coating mixture in the edible coating composition (e.g., solution, suspension, or colloid) is about 1 g/L to 200 g/L. For example, about 1 to 150 g/L, 1 to 100 g/L, 1 to 75 g/L, 10 to 75 g/L, 10 to 50 g/L, 25 to 75 g/L, 35 to 65 g/L, 40 to 60 g/L, or 45 to 55 g/L.

In some embodiments, the edible coating composition includes a base. Examples of bases that can be used include NaOH, KOH, LiOH, NH₄OH NaHCO₃, KHCO₃, LiHCO₃, Na₂CO₃, K₂CO₃, and Li₂CO₃. For example, the base is NaOH. For example, the base is NaHCO₃.

In some embodiments, the base is provided in the edible coating composition in an amount of about 0.01 to about 2 molar equivalents relative to the molar amount of the one or more of lecithin, lysolecithin, and ammonium phosphatide. For example, the base is provided in the edible coating composition in an amount of about 0.1 molar equivalents to about 1.5 molar equivalents, about 0.1 molar equivalents to about 1 molar equivalents, or about 0.3 molar equivalents to about 0.7 molar equivalents, relative to the molar amount of the one or more of lecithin, lysolecithin, and ammonium phosphatide. In some embodiments, the base is provided in the edible coating composition in an amount of about 0.5 molar equivalents relative to the molar amount of the one or more of lecithin, lysolecithin, and ammonium phosphatide. In some embodiments, the base is provided in a solution. In some embodiments, the base is provided in a 0.1M to about 10M solution, or about a 0.5M to about 5M solution, or about 1M to about 3M solution.

In some embodiments, an inorganic salt (e.g., NaCl, KCl) can be included in the solvent (e.g., water) to aid mixing. In some embodiments, a total amount of inorganic salt in the solvent is at least 1 ppm, at least 3 ppm, at least 5 ppm, at least 10 ppm, at least 20 ppm, at least 30 ppm, at least 50 ppm, at least 100 ppm, at least 150, at least 200, at least 250 ppm, or at least 500 ppm. In some embodiments, a total amount of inorganic salt in the solvent is not more than 10 ppm, not more than 20 ppm, not more than 30 ppm, not more than 50 ppm, not more than 100 ppm, not more than 150, not more than 200, not more than 250 ppm, not more than 500 ppm, or not more than 1000 ppm.

As described above, the coating mixture can be added to or dissolved, suspended, or dispersed in a solvent to form a colloid, suspension, or solution. The various components of the coating mixture (e.g., one or more monoglycerides, one or more fatty acid salts, and one or more of lecithin, lysolecithin, and an ammonium phosphatide) can be combined prior to being added to the solvent and then added to the solvent together. Alternatively, the components of the coating mixture can be kept separate from one another and then be added to the solvent consecutively (or at separate times).

In some embodiments, the coating mixture or edible coating composition can further include one or more (e.g., 1, 2, or 3) preservatives. In some embodiments, the one or more preservatives comprise one or more antioxidants, one or more antimicrobial agents, one or more chelating agents, or any combination thereof. Exemplary preservatives include, but are not limited to, vitamin E, vitamin C, butylated hydroxyanisole (BHA), butylated hydroxytoluene (BHT), sodium benzoate, disodium ethylenediaminetetraacetic acid (EDTA), citric acid, benzyl alcohol, benzalkonium chloride, butyl paraben, chlorobutanol, meta cresol, chlorocresol, methyl paraben, phenyl ethyl alcohol, propyl paraben, phenol, benzoic acid, sorbic acid, methyl paraben, propyl paraben, bronidol, and propylene glycol.

In some embodiments, the coating mixture or edible coating composition includes about 0.1% to about 40% by weight of the one or more preservatives. For example, the mixture or composition (e.g., coating or coating agent) includes about 0.1% to about 35%, about 0.1% to about 25%, about 0.1% to about 20%, about 0.1% to about 10%, about 0.1% to about 5%, about 0.1% to about 3%, about 0.1% to about 2%, about 0.1% to about 1%, about 0.1% to about 0.5% by weight of the one or more preservatives.

The coating mixture that is added to the solvent can be composed about 0.1% to about 50% (e.g., about 0.1%-40%, about 0.1%-25%, about 0.1%-10%, about 0.1%-5%, about 1%-50%, about 1%-25%, about 1%-5%, or about 1%-4%) by mass of a second group of compounds of fatty acids, fatty acid esters, fatty acid salts, or combinations thereof, where each compound of the second group is different from the first.

Any of the edible coating compositions described herein can further include additional materials (e.g., additives) that are also transported to the surface with the coating, or are deposited separately and are subsequently encapsulated by the coating (e.g., the coating is formed at least partially around the additional material), or are deposited separately and are subsequently supported by the coating (e.g., the additional material is anchored to the external surface of the coating). In some embodiments, any of the edible coating compositions described herein can further comprise one or more additives. In some embodiments, the additive comprises one or more of or is selected from the group consisting of a preservative, a stabilizer, a buffer, a vitamin, a mineral, a pH modifier, a salt, a pigment, a fragrance, an enzyme, a catalyst, an antioxidant, an antifungal, an antimicrobial, or a combination thereof.

In some embodiments, the stabilizer is alginic acid, agar, carrageenan, pectin, or combinations thereof.

In some embodiments, the buffer is a citrate salt, a phosphate salt, a tartrate salt, or combinations thereof.

In some embodiments, the preservative is a nitrite derivative or salt thereof, a sulfite derivative or salt thereof, a benzoate derivative or salt thereof, or combinations thereof. In some embodiments, the preservative is butylated hydroxyanisole (E320), butylated hydroxytoluene (E321), or combinations thereof.

In some embodiments, the vitamin is vitamin A or derivatives thereof, vitamin B or derivatives thereof, vitamin C or derivatives thereof, vitamin D or derivatives thereof, vitamin E or derivatives thereof, or combinations thereof.

In some embodiments, the mineral is a macromineral, a trace mineral, or combinations thereof. In some embodiments, the mineral is iron, manganese, copper, iodine, zinc, cobalt, fluoride, selenium, or combinations thereof.

In some embodiments, the pigment is blue #1, blue #2, green #3, red #3, red #40, yellow #5, yellow #6, citrus red #2, corresponding aluminum lakes thereof, or combinations thereof.

In some embodiments, the enzyme is an enzyme preparation such as a decarboxylase, an aminopeptidase, an amylase, an asparaginase, a carboxypeptidase, a catalase, a cellulase, a chymosin, a cyprosin, a ficin, a glucanase, an isomerase, a glutaminase, an invertase, a lactase, a lipase, a lyase, a lysozyme, a mannase, an oxidase, a pectinase, a peptidase, a peroxidase, a phospholipase, a protease, a trypsin, a urease, or combinations thereof.

In some embodiments, the antioxidant is an anti-oxidant vitamin, a tocopherol, a gallate or derivative thereof, or combinations thereof. In some embodiments, the antioxidant is 4-hexylresorcinol ascorbic acid or a fatty acid esters thereof, sodium ascorbate, calcium ascorbate, citric acid, erythorbic acid, sodium erythorbate, tertiary-butyl hydroquinone, butylated hydroxyanisole, butylated hydroxytoluene, or combinations thereof.

In some embodiments, the compositions further comprise a pH modifier. In some embodiments, the pH modifier is an acid. In some embodiments, the pH modifier is a base. The pH modifier can include, for example, citric acid, acetic acid, hydrochloric acid, sulfuric acid, phosphoric acid, hydrobromic acid, ascorbic acid, tartaric acid, formic acid, gluconic acid, lactic acid, oxalic acid, boric acid, or a combination thereof.

In some embodiments, the compositions further comprise a food-safe antimicrobial. In some embodiments, the food-safe antimicrobial comprises one or more of or is selected from the group consisting of sodium benzoate, potassium sorbate, carvacrol, chalcone, fludioxonil, 2-hydroxychalcone, 4-hydroxychalcone, 4′-hydroxychalcone, 2,2′-dihydroxychalcone, 2,4′-dihydroxychalcone, 2′,4-dihydroxychalcone, 2′,4′-dihydroxychalcone, 2′,4,4′-trihydroxychalcone, 2′,4,4′-trihydroxychalcone intermediate, violastyrene, obtusaquinone, apiole, piperine, celastrol, eugenol, arthonoic acid, leoidin, antimycin A, antimycin A1, diffractaic acid, ethyl orsellinate, methyl orsellinate, mycophenolic acid, ethyl dichloroorsellinate, angolensin, isocotoin, eupatoriochromene, xanthoxylin, usnic acid, aloin, ononetin, apocynin, isopomiferin, deoxysappanone B7,4′-dimethyl ether, chrysin dimethyl ether, bergapten, gambogic acid, 2-hydroxyxanthone, isopimpinellin, xanthyletin, acetyl hymetochrome, nobiletin, hymechrome, methoxsalen, 4-methylesculetin, tangeritin, khellin, flavone, 3,4′,5,6,7-pentamethoxyflavone, deguelin(−), citropten, deoxysappanone B trimethyl ether, deoxysappanone B 7,3′-dimethyl ether, 2′,4′-dihydroxy-4-methoxychalcone, daunorubicin hydrochloride, plumbagin, menadione, thymoquinone, levomenthol, thymol, methyl trimethoxycinnamate, chavicol, cinnamylphenol, benzoate, napthoquinone, phenone, acetophenone, benzophenone, phenylacetophenone, salicylic acid, sodium salicylate, methyl salicylate, or chitosan. In some embodiments, the one or more food-safe antimicrobials is benzoate. In some embodiments, the one or more food-safe antimicrobials is sodium benzoate, potassium benzoate, or a combination thereof. In some embodiments, the one or more food-safe antimicrobials is sodium benzoate. In some embodiments, the one or more food-safe antimicrobials is chalcone. In some embodiments, the antifungal comprises one or more of or is selected from the group consisting of imidazole, epicatechin, methyl salicylate (MeSA), and combinations thereof.

In some embodiments, the edible coating composition can include an additive configured, for example, to modify the viscosity, vapor pressure, surface tension, or solubility of the coating. The additive can, for example, be configured to increase the chemical stability of the coating. For example, the additive can be an antioxidant configured to inhibit oxidation of the coating. In some embodiments, the additive can reduce or increase the melting temperature or the glass-transition temperature of the coating. In some embodiments, the additive is configured to reduce the diffusivity of water vapor, oxygen, CO₂, or ethylene through the coating or enable the coating to absorb more ultraviolet (UV) light, for example to protect the agricultural product (or any of the other products described herein). In some embodiments, the additive can be configured to provide an intentional odor, for example a fragrance (e.g., smell of flowers, fruits, plants, freshness, scents, etc.). In some embodiments, the additive can be configured to provide color and can include, for example, a dye or a US Food and Drug Administration (FDA) approved color additive.

Any of the coating mixtures or edible coating compositions described herein can be flavorless or have high flavor thresholds (e.g., above 500 ppm), and can be odorless or have a high odor threshold. In some embodiments, the materials included in any of the coatings described herein can be substantially optically transparent. For example, the coating mixture, the solvent, and/or any other additives included in the edible coating composition or coating composition can be selected so that they have substantially the same or similar indices of refraction. By matching their indices of refraction, they may be optically matched to reduce light scattering and improve light transmission. For example, by utilizing materials that have similar indices of refraction and have a clear, optically transparent property, a coating having substantially transparent characteristics can be formed.

The edible coating compositions described herein can be of high purity. For example, the compositions can be substantially free of (e.g., be less than 10%, 5%, or 1% by weight) diglycerides, triglycerides, acetylated monoglycerides, proteins, polysaccharides, phenols, lignans, aromatic acids, terpenoids, flavonoids, carotenoids, alkaloids, alcohols, alkanes, and/or aldehydes. In some embodiments, the compositions comprise less than 10% (e.g., less than 5% or 1%) by weight of diglycerides. In some embodiments, the compositions comprise less than 10% (e.g., less than 5% or 1%) by weight of triglycerides. In some embodiments, the compositions comprise less than 10% (e.g., less than 5% or 1%) by weight of acetylated monoglycerides.

### Coated Agricultural Product

In one aspect, the edible coating composition can be coated onto an agricultural product. Any of the coatings described herein can be disposed on the external surface of an agricultural product or other substrate using any suitable means. For example, the substrate can be dip-coated in a bath of the coating formulation (e.g., an aqueous or mixed aqueous-organic or organic solution). The deposited coating can form a thin layer on the surface of an agricultural product, which can protect the agricultural product from biotic stressors, water loss, respiration, and/or oxidation. In some embodiments, the deposited coating can have a thickness of less than 20 microns, less than 10 microns, less than 5 microns, about 100 nm to about 20 microns, about 100 nm to about 2 microns, about 700 nm to about 1 micron, about 1 micron to about 1.6 microns, about 1.2 microns to about 1.5 microns, and/or the coating can be optically transparent to the naked eye.

In some embodiments, the deposited edible coating composition can be deposited substantially uniformly over the substrate and can be free of defects and/or pinholes. In some embodiments, the dip-coating process can include sequential coating of the agricultural product in baths of coating precursors that can undergo self-assembly or covalent bonding on the agricultural product to form the coating composition. In some embodiments, the coating composition can be deposited on agricultural products by passing the agricultural products under a stream of the edible coating composition solution/suspension/colloid (e.g., a waterfall of the coating solution/suspension/colloid). For example, the agricultural products can be disposed on a conveyor that passes through the stream of the coating solution/suspension/colloid. In some embodiments, the coating can be misted, vapor- or dry vapor-deposited on the surface of the agricultural product. In some embodiments, the coating solution/suspension/colloid can be mechanically applied to the surface of the product to be coated, for example by brushing it onto the surface. In some embodiments, the coating can be configured to be fixed on the surface of the agricultural product by UV crosslinking or by exposure to a reactive gas, for example oxygen.

In some embodiments, the coating solutions/suspensions/colloids can be spray-coated on the agricultural products. Commercially available sprayers can be used for spraying the coating solutions/suspensions/colloids onto the agricultural product. In some embodiments, the coating formulation can be electrically charged in the sprayer before spray-coating on to the agricultural product, such that the deposited coating electrostatically and/or covalently bonds to the exterior surface of the agricultural product.

The edible coating compositions formed from coating mixtures described herein can be configured to prevent water loss or other moisture loss from the coated portion of an agricultural product, delay ripening, prevent oxygen diffusion into the coated portion of the agricultural product, or combinations thereof, for example, to reduce oxidation of the coated portion of the agricultural product. The coatings can also serve as a barrier to diffusion of carbon dioxide and/or ethylene into or out of the agricultural product. The coatings can also protect the coated portion of the agricultural product against biotic stressors, such as, for example, bacteria, fungi, viruses, and/or pests that can infest and decompose the coated portion of the agricultural product. Since bacteria, fungi, and pests identify food sources via recognition of specific molecules on the surface of the agricultural product, coating the agricultural products with the edible coating composition can deposit molecularly contrasting molecules on the surface of the portion of the agricultural product, which can render the agricultural products unrecognizable. Furthermore, the coatings can also alter the physical and/or chemical environment of the surface of the agricultural product making the surface unfavorable for bacteria, fungi or pests to grow. The coatings can also be formulated to protect the surface of the portion of the agricultural product from abrasion, bruising, or otherwise mechanical damage, and protect the portion of the plant from photodegradation.

Any of the edible coatings compositions described herein can be used to reduce the humidity generated by agricultural products (e.g., fresh produce) via mass loss (e.g., water loss) during transportation and storage by reducing the mass loss rate of the agricultural products (e.g., fresh produce).

In some embodiments, the agricultural product is coated with an edible coating composition that reduces the mass loss rate by at least 10%, 20%, 30%, 40%, 45%, 50%, 55%, 60%, 65%, 70%, 80%, 90% or greater compared to untreated product measured. In some embodiments, treating an agricultural product using any of the coatings described herein can give a mass loss factor of at least 1.1, at least 1.2, at least 1.3, at least 1.4, at least 1.5, at least 1.6, at least 1.7, at least 1.8, at least 1.9, at least 2.0, at least 2.2, at least 2.4, at least 2.6, at least 2.8, or at least 3.0. In some embodiments, treating an agricultural product using any of the coatings described herein can reduce the humidity generated during storage by at least 1%, 5%, 10%, 20%, 30%, 40%, 50%, 60%, 70%, 80%, 90% or greater compared to untreated product. In some embodiments, the reduction in mass loss rate of the agricultural product can reduce the energy required to maintain a relative humidity at a predetermined level (e.g., at 90% relative humidity or less, at 85% relative humidity or less, at 80% relative humidity or less, at 75% relative humidity or less, at 70% relative humidity or less, at 65% relative humidity or less, at 60% relative humidity or less, at 55% relative humidity or less, at 50% relative humidity or less, or at 45% relative humidity or less) during storage or transportation. In some embodiments, the energy required to maintain a relative humidity at the predetermined level (e.g., any of the predetermined levels listed above) during storage or transportation can be reduced by at least 1%, 5%, 10%, 20%, 30%, 40%, 50%, 60%, 70%, 80%, 90% or greater compared to untreated product.

Any of the edible coating compositions described herein can be used to reduce the heat generated by agricultural products (e.g., fresh produce) via respiration during transportation and storage by reducing the respiration rate of the agricultural products (e.g., fresh produce). In some embodiments, the product is coated with an edible coating composition that reduces the respiration rate by at least 10%, 20%, 30%, 40%, 50%, 60%, 70%, 80%, 90% or greater compared to untreated product (measured as described above). In some embodiments, the reduction in heat generated by the agricultural product can reduce the energy required to maintain a temperature (e.g., a predetermined temperature) during storage or transportation. In some embodiments, the heat generated can be reduced by at least 5%, 10%, 20%, 30%, 40%, 50%, 60%, 70%, 80%, 90% or greater for coated products compared to untreated products. In some embodiments, the energy required to maintain the coated products at a predetermined temperature (e.g., at 25° C. or less, at 23° C. or less, at 20° C. or less, at 18° C. or less, at 15° C. or less, at 13° C. or less, at 10° C. or less, at 8° C. or less, at 5° C. or less, or at 3° C. or less) can be reduced by at least 1%, 5%, 10%, 20%, 30%, 40%, 50%, 60%, 70%, 80%, 90% or greater compared to untreated products.

Any of the edible coating compositions described herein can be used to protect any agricultural product. In some embodiments, the edible coating composition can be coated on an edible agricultural product, for example, fruits, vegetables, edible seeds and nuts, herbs, spices, produce, meat, eggs, dairy products, seafood, grains, or any other consumable item. In such embodiments, the edible coating composition can include components that are non-toxic and safe for consumption by humans and/or animals. For example, the coating can include components that are U.S. Food and Drug Administration (FDA) approved direct or indirect food additives, FDA approved food contact substances, satisfy FDA regulatory requirements to be used as a food additive or food contact substance, and/or is an FDA Generally Recognized as Safe (GRAS) material. Examples of such materials can be found within the FDA Code of Federal Regulations Title 21, located at “www.accessdata.fda.gov/scripts/cdrh/cfdocs/cfcfr/cfrsearch.cfm”, the entire contents of which are hereby incorporated by reference herein. In some embodiments, the components of the coating can include a dietary supplement or ingredient of a dietary supplement. The components of the coating can also include an FDA approved food additive or color additive. In some embodiments, the coating can include components that are naturally derived, as described herein. In some embodiments, the coating can be flavorless or have a high flavor threshold of below 500 ppm, are odorless or have a high odor threshold, and/or are substantially transparent. In some embodiments, the coating can be configured to be washed off an edible agricultural product, for example, with water.

Accordingly, the materials of this disclosure can be hydrophobic, hydrophilic, lipophilic, lipophobic, omniphobic, gas impermeable, grease impermeable, oil impermeable, gas resistant, grease resistant, oil resistant, or any combination thereof. The hydrophilicity, hydrophobicity, lipophobicity, and lipophobicity of the material according to this disclosure can be measured according to methods known to those skilled in the art (e.g., by measuring the contact angle of the material on a substrate, such as the surface of an agricultural product, with a goniometer). For the purposes of this disclosure, a contact angle of water on the material of less than 50° (e.g., less than 45°, less than 40°, less than 35°, less than 30°, less than 20°, or less than 10°) means that the material is hydrophilic, and a contact angle of water on the material greater than 50° (e.g., greater than 60°, greater than 70°, greater than 80°, greater than 90°, greater than 100°, or greater than 110°) on a material means the material is hydrophobic. In some embodiments, the materials according to this disclosure are hydrophobic, i.e., have a contact angle of water on the material of greater than 50°, greater than 60°, greater than 70°, greater than 80°, greater than 90°, greater than 100°, or greater than 110°. In some embodiments, the materials according to this disclosure are hydrophilic, i.e., have a contact angle of water on the material less than 50°, less than 45°, less than 40°, less than 35°, less than 30°, less than 20°, or less than 10°. For the purposes of this disclosure, a contact angle of oil (e.g., plant-based oil) on the material less than 50 (e.g., less than 45°, less than 40°, less than 35°, less than 30°, less than 20°, or less than 10°) means that the material is lipophilic, and a contact angle of oil on the material greater than 500 (e.g., greater than 60°, greater than 70°, greater than 80°, greater than 90°, greater than 100°, or greater than 110°) on a material means the material is lipophobic. In some embodiments, the materials according to this disclosure are oil repellant (lipophobic), i.e., have a contact angle of oil on the material greater than 500 greater than 60°, greater than 70°, greater than 80°, greater than 90°, greater than 100°, or greater than 110°. In some embodiments, the materials according to this disclosure are not oil repellant (lipophilic), i.e., have a contact angle of oil on the material less than 50°, less than 45°, less than 40°, less than 35°, less than 30°, less than 20°, or less than 10°. In some embodiments, the materials according to this disclosure are omniphobic (e.g., have a contact angle of oil on the material and a contact angle of water on the material greater than 50°, greater than 60°, greater than 70°, greater than 80°, greater than 90°, greater than 100°, or greater than 110°).

As used herein, the term “contact angle” of a liquid on a solid surface refers to an angle of the outer surface of a droplet of the liquid measured where the liquid-vapor interface meets the liquid-solid interface.

### Methods of Preparing the Edible Coating Composition

Provided herein are methods of preparing an edible coating composition. The method includes combining a solvent and a base in a reservoir to yield a first mixture; and combining the first mixture and a coating mixture to yield the edible coating compositions as disclosed herein, wherein the coating mixture is any embodiment as disclosed above. In some embodiments, the coating mixture includes one or more monoglycerides, one or more fatty acid salts, and one or more of lecithin, an ammonium phosphatide, and lysolecithin. In some embodiments, the coating mixture includes about 75 wt % to about 98 wt % of one or more monoglycerides; about 1 wt % to about 5 wt % of one or more fatty acid salts; and about 1 wt % to about 20 wt % of one or more of lecithin, an ammonium phosphatide, and lysolecithin. In some embodiments, the solvent is a solvent as disclosed above.

In some embodiments, combining the first mixture and the coating mixture includes blending (e.g., homogenizing) the first mixture and the coating mixture. In some embodiments, the coating mixture and first mixture described herein are homogenized prior to the application to the plant matter and/or agricultural product. In some embodiments, the solvent includes water. In some embodiments, the solvent is water. In some embodiments, the water is deionized water. In some embodiments, the first mixture is heated. In some embodiments, the first mixture is heated to a temperature of about 40° C. to about 100° C. In some embodiments, the first mixture is heated to about 50° C. to about 100° C., about 50° C. to about 90° C., or about 50° C. to about 80° C. about, or about 50° C. to about 70° C. In some embodiments, the first mixture is heated to about 40° C. to about 100° C. or about 50° C. to about 70° C. about. In some embodiments, the first mixture is heated to about 50° C. to about 70° C. In some embodiments, the first mixture is heated to about 90° C.

In some embodiments, the method includes blending (e.g., homogenizing) the coating mixture with the water and base for a period of time. In some embodiments, any of the edible coating compositions and/or the coating mixtures described herein are homogenized using any suitable method of homogenization. Commercially available homogenizing devices can be used to homogenize the edible coating composition and/or the coating mixture. In some embodiments, the edible coating composition and/or the coating mixture is homogenized using a blender. In some embodiments, the coating mixture and the first mixture are blended for a period of time of about 1 minute to about 2 hours, about 1 minute to 1 hour, about 1 minute to 30 minutes, about 10 minutes to about 30 minutes, about 5 minutes to about 15 minutes, or about 10 minutes to about 15 minutes.

### Methods of Use and Application

Provided herein are methods of coating a substrate. The method includes applying the edible coating composition to a surface of an agricultural product, and drying the edible coating composition on the surface of the agricultural product. In some embodiments, drying the edible coating composition includes a forced flow of air at a temperature greater than room temperature.

In some embodiments, the temperature of the edible coating composition while applying to a surface of an agricultural product is between 10° C. and 80° C. For example, the temperature of the edible coating composition is between 10° C. and 70° C., between 20° C. and 80° C., between 20° C. and 60° C., between 20° C. and 30° C., or between 40° C. and 70° C. In some embodiments, the temperature of the edible coating composition is between 10° C. and 30° C., or ambient temperature (e.g., a room temperature of a packing house).

In some embodiments, the temperature of the air while drying the edible coating composition is between 20° C. and 120° C. For example, the temperature of the air is between 20° C. and 100° C., between 40° C. and 120° C., or between 50° C. and 100° C. In some embodiments, the temperature of the air is between 60° C. and 80° C., between 65° C. and 75° C., or about 70° C.

In some embodiments, the edible coating composition can be dried for a period of time of about 10 minutes to about 120 minutes, or about 30 minutes to about 100 minutes, or about 40 minutes or about 80 minutes.

Any of the edible coating compositions can be disposed on the external surface of an agricultural product using any suitable means. In some embodiments, the agricultural product can be dip coated in a bath of the edible coating composition. In some embodiments, applying the edible coating composition to the agricultural product includes dipping the agricultural product in the edible coating composition. The edible coating composition can form a thin layer on the surface of the agricultural product, which can protect the agricultural product from biotic stressors, water loss, and/or oxidation.

In some embodiments, any of the edible coating compositions described herein, can be spray coated on the agricultural product. In some embodiments, applying the composition to the surface of the agricultural product comprises spraying the edible coating composition, the on the surface of the agricultural product. Commercially available sprayers can be used for spraying the edible coating composition onto the surface of the agricultural product.

In some embodiments, the edible coating composition can be deposited on an agricultural product by passing the agricultural products under a stream of the edible coating composition (e.g., a waterfall of the edible coating composition). For example, the agricultural product can be disposed on a conveyor that passes through the stream of the edible coating composition. In some embodiments, the edible coating composition can be vapor deposited on the surface of the agricultural product. In some embodiments, the edible coating composition can be applied in the field before harvest. In some embodiments, the edible coating composition is applied to the agricultural product pre-harvest. In some embodiments, the edible coating composition can be applied to the agricultural product after harvest (e.g., after the agricultural product has been separated from where the majority of growth has taken place). In some embodiments, edible coating composition is applied to the agricultural product post-harvest.

In some embodiments, the deposited edible coating composition can have a thickness of less than about 2 microns, for example less than 1 micron, less than 500 nm, less than 200 nm, or less than 100 nm, such that the edible coating composition is transparent to the naked eye. For example, the edible coating composition can have a thickness of about 50 nm to about 1000 nm, such as 100 nm, 200 nm, 250 nm, 300 nm, 500 nm, or 750 nm.

In some embodiments, the agricultural product can be plant matter such as a flower or produce (e.g., fresh produce). In some embodiments, the agricultural product comprises one or more of or is selected from the group consisting of a fruit, a vegetable, a leaf, a stem, bark, a seed, a flower, and a combination thereof. In some embodiments, the agricultural product is a flower. In some embodiments, the agricultural product is fresh produce. In some embodiments, the agricultural product is a vegetable. In some embodiments, the agricultural product is a fruit.

In some embodiments, following the application of the edible coating composition to the agricultural product desiccation is reduced. In some embodiments, following application of the edible coating composition the rate of water lost from the agricultural product is reduced. In some embodiments, desiccation is measured with mass loss. In some embodiments, following the application of the edible coating composition the rate of mass loss is reduced. In some embodiments, water loss is measured by mass loss. Mass loss, for example, can be measured by determining the difference between the weight of agricultural product after application of the edible coating composition and after a certain period of time passes. In some embodiments, mass loss is measured after 1 day, 2 days, 3 days, 4 days, 5 days, 6 days, 7, days, 8 days, 9 days, and/or 10 days or after any combination thereof. In some embodiments, mass loss is measured after 1 week, after 2 weeks, after 3 weeks, after 4 weeks, after 5 weeks, after 6 weeks, after 7 weeks, after 8 weeks, after 9 weeks, after 10 weeks, after 11 weeks, after 12 weeks, or after any combination thereof.

In some embodiments, following application of the edible coating composition the respiration rate of the agricultural product can be reduced. For example, the application of any of the edible coating composition described herein can be used to block or limit diffusion of gasses such as ethylene, CO₂, and O₂, among others, thereby slowing ripening and/or senescence. In some embodiments, following the application of the edible coating composition, the rate of CO₂ production by the agricultural product is reduced.

The foregoing description and following examples detail certain specific embodiments of the disclosure and describe the best mode that the inventors contemplated. It will be appreciated, however, that no matter how detailed the foregoing may appear in text, the disclosure may be practiced in many ways, and the disclosure should be construed in accordance with the appended claims and equivalents thereof.

Although the disclosed teachings have been described with reference to various applications, methods, compounds, compositions, and materials, it will be appreciated that various changes and modifications to them may be made without departing from the teachings herein. The following examples are provided to better illustrate the disclosed teachings and are not intended to limit the scope of the teachings presented herein. While the present teachings have been described in terms of these exemplary embodiments, the skilled artisan will readily understand that numerous variations and modifications of these exemplary embodiments are possible without undue experimentation. All such variations and modifications are within the scope of the teachings of this disclosure.

### EXAMPLES

The following examples describe effects of various coating compositions and solutions/suspensions/colloids on various substrates, as well as characterization of some of the various coating compositions and solutions/suspensions/colloids. These examples are only for illustrative purposes and are not meant to limit the scope of the present disclosure. In each of the examples below, all reagents and solvents were purchased and used without further purification unless specified.

### Materials and Methods

The materials and methods of the disclosure will be further described in the following examples, which do not limit the scope of the methods and compositions of matter described in the claims. Glycerol monostearate is a thermodynamic mixture obtained from commercial sources generally having a molar ratio of 1-glycerol monostearate to 2-glycerol monostearate of about 9:1. Oiled and de-oiled lecithin was obtained from commercial suppliers (e.g., GSRN, Sternpure, Lessenor, or Solec).

### Example 1: Effect of Coatings Formed on Mandarins on Mass Loss Factor

Table 1 lists the mass loss factor (“MLF”) of mandarins coated with various coating compositions including edible coating compositions disclosed herein and the corresponding error propagation (EP). Each sample represents the average MLF for a group of 5 mandarins. The untreated mandarins were not treated with a coating composition. The mandarins of Sample 1-6 were coated with the compositions listed in Table 1.

To form the coating compositions, the coating mixtures were combined with water and admixed together to form the coating compositions. For coating compositions that included a base, the base was added to water followed by the addition of the coating mixture, and the components were admixed together.

To form the coating compositions on the mandarins, the mandarins were hand-dipped in a bowl of coating composition until the mandarins were fully submerged in the coating composition and pulled out of the bowl to form coated mandarins. The coated mandarins were then allowed to dry in a drying tunnel at a temperature of about 70° C. for about 90 seconds. The coated mandarins were kept under ambient room conditions at a temperature in the range of about 23° C.-27° C. and humidity in the range of about 40%-55% for about 3 days.

MLF for the untreated mandarins is defined as 1.00. The MLFs for the coated mandarins with the coating compositions described herein exhibited at least a 20% increase in MLF from the untreated mandarins. For example, the mandarins in Sample 6 exhibited about a 90% increase in MLF from the untreated mandarins, and about a 27% increase from the mandarins of Sample 1.

TABLE 1
Coating Composition and MLF of Samples 1-6

| Sample | MLF ± EP | Coating Composition | Coating Mixture Composition |
|---|---|---|---|
| Untreated | 1.00 ± 0.04 | — | — |
| 1 | 1.50 ± 0.05 | 50 g/L coating mixture in water | 95 wt % glycerol monostearate |
| | | | and 5 wt % sodium stearate |
| 2 | 1.48 ± 0.05 | 50 g/L coating mixture and 2 g/L | 95 wt % glycerol monostearate |
| | | xanthan gum in water | and 5 wt % sodium stearate |
| 3 | 1.32 ± 0.05 | 50 g/L of a coating mixture, about 5 g/L | 95 wt % glycerol monobehenate |
| | | of glycerol monolaurate, and about 2 | and 5 wt % sodium stearate |
| | | g/L of xanthan gum in water | |
| 4 | 1.18 ± 0.04 | 50 g/L coating mixture, about 5 g/L of | 95 wt % glycerol monobehenate |
| | | glycerol monocaprate, and 2 g/L of | and 5 wt % sodium stearate |
| | | xanthan gum in water | |
| 5 | 1.35 ± 0.04 | 50 g/L coating mixture and 5 g/L | 95 wt % glycerol monobehenate, |
| | | glycerol monolaurate in water | 2 wt % sodium stearate, and 3 |
| | | | wt % lysolecithin |
| 6 | 1.97 ± 0.09 | 50 g/L of a coating mixture in water | 95 wt % glyceryl monostearate |
| | | including 0.5 molar equivalents relative | and 5 wt % lecithin |
| | | to the amount of lecithin of 1M NaOH | |

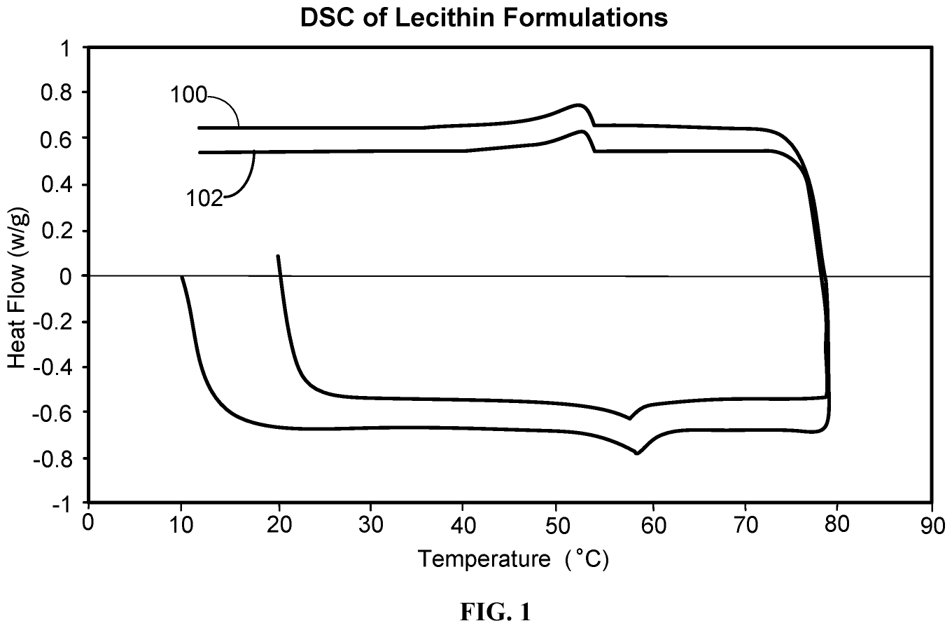

The coating compositions of Samples 5 and 6 were characterized by DSC. The DSC of Samples 5 and 6 are shown in FIG. 1 as plots 100 and 102, respectively. The DSC of the coating compositions was characterized as follows. The DSC of the coating compositions were taken on a TA Instrument Discovery DSC 250. The coating compositions (10-15 mg) were pipetted into a Tzero pan. The Tzero pan was loaded into the DSC instrument along with a reference pan. The instrument was equilibrated to 20° C. Then the coating compositions were heated from 20° C. to 80° C. at a rate of 10° C./minute. The coating compositions were then cooled from 80° C. to 10° C. at a rate of 10° C./minute. The coating compositions were heated from 10° C. to 80° C. at a rate of 10° C./minute and cooled from 80° C. to 10° C.

### Example 2: Effect of Lysolecithin Coatings Formed on Avocados on MLF

Table 2 lists the MLF of avocados coated with various coating compositions including edible coating compositions disclosed herein. Each sample represents the average MLF for a group of 30 avocados. The untreated avocados were not treated with a coating composition. The avocados of Samples 7-12 were coated with the compositions listed in Table 2.

To form the coating compositions, the coating mixtures were combined with water and admixed together to form the coating compositions.

To form the coating compositions on the avocados, the avocados were dip-coated in the composition to form coated avocados. The coated avocados were then allowed to dry in a drying tunnel at a temperature of about 70° C. for about 90 seconds. The coated avocados were kept under ambient room conditions at a temperature in the range of about 23° C.-27° C. and humidity in the range of about 40%-55% for the entire duration of the time they were tested, about 3 days.

MLF for the untreated avocados is defined as 1.00. The MLFs for the coated avocados with the coating compositions described herein exhibited at least a 90% increase in MLF from the untreated avocados. For example, the avocados coated with the coating composition of Sample 12 exhibited about a 1500 increase in MLF from the untreated avocados.

TABLE 2
Coating Composition and MLF of Samples 7-12

| Sample | MLF ± EP | Coating Composition | Coating Mixture Composition |
|---|---|---|---|
| Untreated | 1.00 ± 0.08 | — | — |
| 7 | 1.92 ± 0.14 | 50 g/L coating mixture and 2 g/L | 90 wt % glyceryl monostearate |
| | | of glyceryl monolaurate in water | and 10 wt % sodium stearate |
| 8 | 1.91 ± 0.13 | 50 g/L coating mixture and 2 g/L | 82 wt % glyceryl monostearate, 8 |
| | | of glyceryl monolaurate in water | wt % sodium stearate, and 10 wt % |
| | | | lysolecithin |
| 9 | 2.06 ± 0.15 | 50 g/L coating mixture and 2 g/L | 95 wt % glyceryl monostearate |
| | | of glyceryl monolaurate in water | and about 5 wt % sodium stearate |
| 10 | 2.05 ± 0.15 | 50 g/L coating mixture and 2 g/L | 90 wt % glyceryl monostearate, 4 |
| | | of glyceryl monolaurate in water | wt % sodium stearate, and 5 wt % |
| | | | lysolecithin |
| 11 | 2.44 ± 0.15 | 50 g/L coating mixture and 2 g/L | 98 wt % glyceryl monostearate |
| | | of glyceryl monolaurate in water | and about 2 wt % sodium stearate |
| 12 | 2.48 ± 0.15 | 50 g/L coating mixture and 2 g/L | 95 wt % glyceryl monostearate, 3 |
| | | of glyceryl monolaurate in water | wt % sodium stearate, and 2 wt % |
| | | | lysolecithin |

### Example 3: Contact Angles of Coating Compositions

Table 3 lists contact angles of various coating compositions. The contact angles were determined by placing drops containing 5 microliters of a coating composition on the surface of a plastic cover slip and determining the contact angle 60 seconds after the drop was placed on the surface of the plastic cover slip by digital image analysis using a sessile drop technique on a Kruss DSA25 goniometer. Each sample represents the average contact angle measurements of 3 drops. The compositions of Samples 13-20 are listed in Table 3.

TABLE 3
Contact Angles of Coating Compositions for Samples 13-20

| Sample | Contact Angle (°) | Coating Composition | Coating Mixture Composition |
|---|---|---|---|
| 13 | 73.4 | 50 g/L coating mixture in water | 96 wt % glycerol monostearate |
| | | | and 4 wt % sodium stearate |
| 14 | 54.3 | 50 g/L coating mixture and 2 | 96 wt % glycerol monostearate |
| | | g/L of glyceryl monolaurate in | and 4 wt % sodium stearate |
| | | water | |
| 15 | 73.9 | 50 g/L coating mixture in water | 95 wt % glyceryl monostearate, |
| | | | 2 wt % sodium stearate, and 3 |
| | | | wt % lysolecithin |
| 16 | 61.8 | 50 g/L coating mixture and 2 | 95 wt % glyceryl monostearate, |
| | | g/L of glyceryl monolaurate in | 2 wt % sodium stearate, and 3 |
| | | water | wt % lysolecithin |
| 17 | 57.2 | 50 g/L coating mixture in water | 96 wt % glyceryl monostearate, |
| | | including 0.5 molar equivalents | 1 wt % sodium stearate, and 3 |
| | | relative to the amount of lecithin | wt % lecithin |
| | | of a 1M NaOH solution | |
| 18 | 41.5 | 50 g/L coating mixture and 2 g/L | 96 wt % glyceryl monostearate, |
| | | of glyceryl monolaurate in water | 1 wt % sodium stearate, and 3 |
| | | including 0.5 molar equivalents | wt % lecithin |
| | | relative to the amount of lecithin | |
| | | of a 1M NaOH solution | |
| 19 | 73.7 | 50 g/L coating mixture in water | 90 wt % glyceryl monostearate |
| | | including 0.5 molar equivalents | and 10 wt % lecithin |
| | | relative to the amount of lecithin | |
| | | of a 1M NaOH solution | |
| 20 | 62.5 | 50 g/L coating mixture and 2 g/L | 90 wt % glyceryl monostearate |
| | | of glyceryl monolaurate in water | and 10 wt % lecithin |
| | | including 0.5 molar equivalents | |
| | | relative to the amount of lecithin | |
| | | of a 1M NaOH solution | |

### Example 4—Viscosity of Coating Compositions

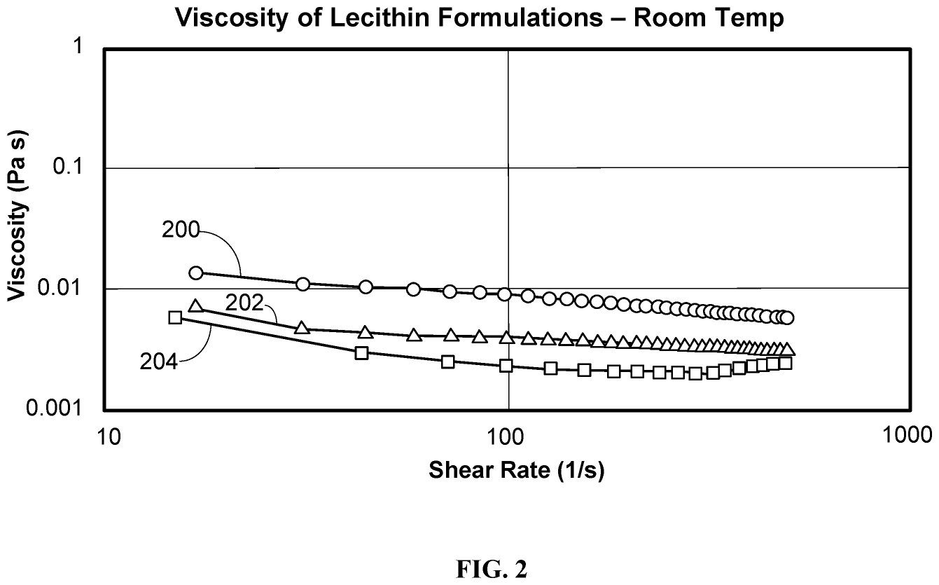

FIG. 2 is a graph showing viscosity versus shear rate for Samples 13, 15, and an additional sample as plots 200, 202, and 204, respectively. The additional sample includes 50 g/L of a coating mixture in water with about 0.5 molar equivalents relative to the amount of lecithin of a 1 M NaOH solution, and the coating mixture was made up of 90 wt % alpha-glyceryl monostearate and 10 wt % lecithin. The viscosity measurements were taken by a TA Instruments DHR. The viscosity measurements were taken at 20° C. running isothermal shear sweep from 15 to 1000 l/sat 20° C.

### Example 5—Effect of Lecithin Coatings Formed on Mandarins on MLF

Table 4 lists the MLF of mandarins coated with various coating compositions including edible coating compositions disclosed herein. Each sample represents the average MLF for a group of 4 mandarins. The untreated mandarins were not treated with a coating composition. The mandarins of Samples 21-31 were coated with the coating compositions listed in Table 4.

To form the coating compositions, the coating mixtures were combined with water, and the coating mixtures and water were admixed together to form the coating compositions. For coating compositions that included a base, the base was added to water followed by the addition of the coating mixture, and the components were admixed together.

To form the coating compositions on the mandarins, the mandarins were hand-dipped in a bowl of coating composition until the mandarins were fully submerged in the coating composition and pulled out of the bowl to form coated mandarins. The coated mandarins were then allowed to dry in a drying tunnel at a temperature of about 70° C. for about 90 seconds. The coated mandarins were kept under ambient room conditions at a temperature in the range of about 23° C.-27° C. and humidity in the range of about 40%-55% for the entire duration of the time they were tested, about 3 days.

The MLF of the untreated mandarins was defined as 1.00. The MLFs for the coated mandarins with the coating compositions described herein exhibited at least a 30% increase in MLF from the untreated mandarins. For example, the mandarins coated with the coating compositions including a base and lecithin in the place of sodium stearate exhibited about a 30% increase in MLF.

TABLE 4
Coating Composition and MLF of Samples 21-31

| Sample | MLF ± EP | Coating Composition | Coating Mixture Composition |
|---|---|---|---|
| Untreated | 1.00 ± 0.04 | — | — |
| 21 | 1.55 ± 0.10 | 50 g/L coating mixture in water | 96 wt % glycerol monostearate |
| | | | and 4 wt % sodium stearate |
| 22 | 1.79 ± 0.09 | 50 g/L coating mixture and 2 g/L | 96 wt % glycerol monostearate |
| | | of monolaurate in water | and 4 wt % sodium stearate |
| 23 | 2.09 ± 0.16 | 50 g/L coating mixture in water | 95 wt % glyceryl monostearate |
| | | including 2.5 mmol of NaOH | and 5 wt % lecithin |
| 24 | 1.94 ± 0.13 | 50 g/L coating mixture in water | 95 wt % glyceryl monostearate |
| | | including 2.5 mmol of NaOH | and 5 wt % lysolecithin |
| 25 | 2.15 ± 0.09 | 50 g/L coating mixture and 2 g/L | 95 wt % glyceryl monostearate |
| | | of glyceryl monolaurate in water | and 5 wt % NH4-phosphatide |
| | | including 3.5 mmol of NaOH | |
| 26 | 1.87 ± 0.07 | 50 g/L coating mixture in water | 95 wt % glyceryl monostearate, |
| | | | 2 wt % sodium stearate, and 3 |
| | | | wt % lysolecithin |
| 27 | 1.86 ± 0.07 | 50 g/L coating mixture in water | 95 wt % glyceryl monostearate, |
| | | including 2.5 mmol of NaOH | 2 wt % sodium stearate, and 3 |
| | | | wt % lysolecithin |
| 28 | 2.26 ± 0.14 | 50 g/L coating mixture in water | 95 wt % glyceryl monostearate |
| | | including 2.5 mmol of NaOH | and 5 wt % oiled lecithin |
| 29 | 2.07 ± 0.07 | 50 g/L coating mixture in water | 95 wt % glyceryl monostearate |
| | | including 2.5 mmol of NaHCO₃ | and 5 wt % oiled lecithin |
| 30 | 1.50 ± 0.08 | 50 g/L coating mixture in water | 100 wt % glyceryl monostearate |
| | | including 4 mmol of NaHCO₃ | |
| 31 | 1.34 ± 0.07 | 50 g/L coating mixture in water | 100 wt % glyceryl monostearate |
| | | including 4 mmol of Na₃PO₄ | |

### Example 6—Mixability of Coating Compositions

Table 5 lists the stability and dispersibility of various compounds. The stability of the compounds is measured via a turbidimeter. When the turbidity exceeds 1.2 times the initial turbidity of a coating composition, it is no longer considered stable. The coating compositions had about 50 g/L of a coating mixture in water. The coating mixture was about 95 wt % glyceryl monostearate and about 5 wt % lecithin, lysolecithin, or NH₄ phosphatide, with or without a base.

TABLE 5
Mixability of Coating Mixtures

| Phosphatide | Base | Dispersed** | Stability* |
|---|---|---|---|
| Lysolecithin | — | no | — |
| Lecithin (oiled) | — | no | — |
| NH₄Phosphatides | — | no | — |
| Cetyl phosphate | — | no | — |
| Lecithin (deoiled) | — | no | — |
| Lysolecithin | NaOH | yes | 12-14 |
| Lecithin (oiled) | NaOH | yes | 12-14 |
| NH₄ Phosphatides | NaOH | yes | 12-14 |
| Cetyl phosphate | NaOH | yes | 7-9 |
| Lecithin (deoiled) | NaOH | yes | 12-14 |
| Lecithin (deoiled) | Na₂CO₃ | yes | TBD |
| Lecithin (deoiled) | NaHCO₃ | yes | TBD |

*Stability is characterized by turbidity.
** Dispersed is characterized by a visual inspection on whether or not solids are dissolved in the water. Upon visual inspection, if solids remain undissolved or if the coating compositions are too viscous, dispersed is “no” and if no solids remain, dispersed is “yes”.

Table 6 shows the mixability of various coating compositions with about 50 g/L of a coating mixture in water. The coating mixture included glyceryl monostearate, lecithin, and optionally sodium stearate. The water optionally had a base and an optional additives. The coating compositions were mixed in a 5-10 L RotoSolver® at a shear rate of 8000 RPM and at a temperature in a range of 50-70° C.

TABLE 6
Mixability of Coating Mixtures

| Glyceryl monostearate/ | | | |
|---|---|---|---|
| Lecithin/Sodium | | | |
| stearate Weight Ratio | Base | Additive | Dispersed |
| 95/5/0 | NaOH (0.5 eq.) | — | No |
| 95/5/0 | NaOH (1 eq.) | — | No |
| 95/5/0 | Na₂CO₃ (0.5 eq.) | — | No |
| 95/5/0 | NaHCO₃ (0.5 eq.) | — | No |
| 95/5/0 | NaHCO₃ (0.5 eq.) | NaCl | No |
| | | (200 ppm) | |
| 95/5/0 | NaHCO₃ (0.5 eq.) | NaCl | No |
| | | (400 ppm) | |
| 90/10/0 | NaHCO₃ (0.5 eq.) | — | Yes |
| 94/5/1 | NaHCO₃ (0.5 eq.) | — | Yes |
| 96/3/1 | NaHCO₃ (0.5 eq.) | — | Yes |
| 98/1/1 | NaHCO₃ (0.5 eq.) | — | No |

Coating compositions that showed better mixability included coating compositions that had higher amounts of lecithin, smaller amounts of sodium stearate, or both.

### Example 7—Effect of Lecithin Amount in the Coating on MLF of Mandarins

Table 7 lists the MLF of mandarins coated with various coating compositions including edible coating compositions disclosed herein. Each sample represents the average MLF for a group of 96 mandarins. The lecithin used in the coating compositions of Example 7 was oiled lecithin. The untreated mandarins were not treated with a coating composition. The mandarins of Samples 32-40 were coated with the compositions listed in Table 7.

To form the coating compositions on the mandarins, the mandarins were hand-dipped in a bowl of coating composition until the mandarins were fully submerged in the coating composition and pulled out of the bowl to form coated mandarins. The coated mandarins were then allowed to dry in a drying tunnel at a temperature of about 70° C. for about 90 seconds. The coated mandarins were kept under ambient room conditions at a temperature in the range of about 23° C.-27° C. and humidity in the range of about 40%-55% for the entire duration of the time they were tested, about 3 days.

The MLF of the untreated mandarins was defined as 1.00. The MLFs for the coated mandarins with the coating compositions having a coating mixture with a lecithin amount of about 1 wt % to about 20 wt % exhibited at least a 50% increase in MLF from the untreated mandarins. For example, Samples 33-35 all exhibited about 3-fold increase in MLF from the untreated mandarins.

TABLE 7
Lecithin Coated Mandarins

| Sample | MLF | Coating Composition | Coating Mixture Composition |
|---|---|---|---|
| Untreated | 1.00 | — | — |
| 32 | 2.42 | 50 g/L coating mixture in water | 96 wt % glycerol monostearate |
| | | | and 4 wt % sodium stearate |
| 33 | 2.95 | 50 g/L coating mixture in water | 95 wt % glycerol monostearate |
| | | including 1 molar equivalents | and 5 wt % lecithin |
| | | relative to the amount of lecithin | |
| | | of a saturated NaHCO₃ aqueous | |
| | | solution | |
| 34 | 3.04 | 50 g/L coating mixture in water | 95 wt % glycerol monostearate |
| | | including 0.5 molar equivalents | and 5 wt % lecithin |
| | | relative to the amount of lecithin | |
| | | of a saturated NaHCO₃ aqueous | |
| | | solution | |
| 35 | 3.17 | 52.5 g/L coating mixture in water | 95 wt % glycerol monostearate |
| | | including 1 molar equivalents | and 10 wt % oiled lecithin |
| | | relative to the amount of lecithin | |
| | | of a saturated NaHCO₃ aqueous | |
| | | solution | |
| 36 | 1.57 | 60 g/L coating mixture in water | 80 wt % glycerol monostearate |
| | | including 1 molar equivalents | and 20 wt % oiled lecithin |
| | | relative to the amount of lecithin | |
| | | of a saturated NaHCO₃ aqueous | |
| | | solution | |
| 37 | 1.00 | 72.5 g/L coating mixture in water | 65.5 wt % glycerol monostearate |
| | | including 1 molar equivalents | and 34.5 wt % oiled lecithin |
| | | relative to the amount of lecithin | |
| | | of a saturated NaHCO₃ aqueous | |
| | | solution | |
| 38 | 0.77 | 97.5 g/L coating mixture in water | 48.5 wt % glycerol monostearate |
| | | including 1 molar equivalents | and 51.5 wt % oiled lecithin |
| | | relative to the amount of lecithin | |
| | | of a saturated NaHCO₃ aqueous | |
| | | solution | |
| 39 | 2.71 | 50 g/L coating mixture and 2 g/L | 95 wt % glyceryl monostearate, |
| | | of glyceryl monolaurate in water | 2 wt % sodium stearate, and 3 |
| | | | wt % lecithin (from Sternpure) |
| 40 | 2.96 | 50 g/L coating mixture and 2 g/L | 95 wt % glyceryl monostearate, |
| | | of glyceryl monolaurate in water | 2 wt % sodium stearate, and 3 |
| | | | wt % lecithin (from Lassenor) |

### Example 8—Effect of Lecithin in the Coatings on MLF of Waxed Limes

Table 8 lists the MLFs of waxed limes coated with various coating compositions including edible coating compositions disclosed herein. Each sample represents the average MLF for a group of 4 waxed limes. The untreated waxed limes were not treated with a coating composition. The waxed limes of Samples 41-46 were coated the compositions listed in Table 8.

To form the coating compositions on the waxed limes, the waxed limes were hand-dipped in a bowl of coating composition until the waxed limes were fully submerged in the coating composition and pulled out of the bowl to form coated waxed limes. The coated waxed limes were then allowed to dry in a drying tunnel at a temperature of about 70° C. for about 90 seconds. The coated wax limes were kept under ambient room conditions at a temperature in the range of about 23° C.-27° C. and humidity in the range of about 40%-55% for the entire duration of the time they were tested, about 3 days.

The MLF of the untreated waxed limes was defined as 1.00. The MLFs for the coated waxed limes with the coating compositions having a coating mixture with a lecithin or lysolecithin amount of about 1 wt % to about 20 wt exhibited at least a 300 increase in MLF from the untreated waxed limes. For example, the waxed limes coated with the coating composition of Samples 43-45 all exhibited at least about a 60% increase in MLF from the untreated waxed limes.

TABLE 8
Lecithin Coated Waxed Limes

| Sample | MLF ± EP | Coating Composition | Coating Mixture Composition |
|---|---|---|---|
| Untreated | 1.00 ± 0.04 | — | — |
| S41 | 1.59 ± 0.07 | 50 g/L coating mixture in water | 96 wt % glycerol monostearate |
| | | | and 4 wt % sodium stearate |
| S42 | 2.11 ± 0.09 | 50 g/L coating mixture in water | 95 wt % glyceryl monostearate, |
| | | | 2 wt % sodium stearate, and 3 |
| | | | wt % lysolecithin |
| S43 | 1.95 ± 0.06 | 55 g/L coating mixture in water | 90 wt % glyceryl monostearate, |
| | | including 0.5 molar equivalents relative | about 0.5 wt % sodium stearate, |
| | | to the amount of lecithin of a saturated | and about 9.5 wt % lecithin |
| | | NaHCO₃ aqueous solution | |
| S44 | 1.60 ± 0.08 | 55 g/L coating mixture in water | 87.7 wt % glyceryl monostearate |
| | | including 0.5 molar equivalents relative | and 12.3 wt % lecithin |
| | | to the amount of lecithin (supplied | |
| | | from Spectrum Chemical) of a | |
| | | saturated NaHCO₃ aqueous solution | |
| S45 | 1.76 ± 0.06 | 55 g/L coating mixture in water | 87.7 wt % glyceryl monostearate |
| | | including 0.5 molar equivalents relative | and 12.3 wt % lecithin |
| | | to the amount of lecithin (supplied | |
| | | from the Solea Company) of a | |
| | | saturated NaHCO₃ aqueous solution | |
| S46 | 1.33 ± 0.05 | 55 g/L coating mixture in water | 80 wt % glyceryl monostearate |
| | | including 0.5 molar equivalents relative | and 20 wt % lecithin |
| | | to the amount of lecithin of a saturated | |
| | | NaHCO₃ aqueous solution | |

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

Embodiment 1 is an edible coating composition comprising:
a coating mixture comprising:
   about 75 wt % to about 98 wt % of one or more monoglycerides;
   about 1 wt % to about 5 wt % of one or more fatty acid salts; and
   about 1 wt % to about 20 wt % of one or more of lecithin, an ammonium phosphatide, and lysolecithin;
a base; and
a solvent.

Embodiment 2 is the composition of embodiment 1, wherein the coating mixture comprises lecithin.

Embodiment 3 is the composition of embodiment 1 or 2, wherein the lecithin is de-oiled.

Embodiment 4 is the composition of any one of embodiments 1-3, wherein the one or more of lecithin, the ammonium phosphatide, and lysolecithin is present in the coating mixture in an amount in a range of about 1 wt % to about 15 wt %, or about 1 wt % to about 12 wt %, 2 wt % to about 8 wt %, or about 3 wt % to about 7 wt %, or about 5 wt %.

Embodiment 5 is the composition of any one of embodiments 1-4, wherein the coating mixture comprises ammonium phosphatide.

Embodiment 6 is the composition of any one of embodiments 1-5, wherein the coating mixture comprises lysolecithin.

Embodiment 7 is the composition of any one of embodiments 1-6, wherein the one or more monoglycerides is present in the coating mixture in an amount of about 80 wt % to about 98 wt %, or 85 wt % to about 98 wt %, or about 90 wt % to about 98 wt %, or about 92 wt % to about 97 wt %, or about 95 wt %.

Embodiment 8 is the composition of any one of embodiments 1-7, wherein the base comprises one or more of NaOH, LiOH, KOH, K₂CO₃, Na₂CO₃, Li₂CO₃, KHCO₃, LiHCO₃, and NaHCO₃.

Embodiment 9 is the composition of any one of embodiments 1-8, wherein the base comprises one or more of NaOH, Na₂CO₃, and NaHCO₃.

Embodiment 10 is the composition of any one of embodiments 1-9, wherein the base comprises NaOH.

Embodiment 11 is the composition of any one of embodiments 1-10, wherein the base is present in an amount in a range of about 0.01 molar equivalents to about 2 molar equivalents relative to the total molar amount of one or more of lecithin, ammonium phosphatide, and lysolecithin, or about 0.1 molar equivalents to about 1.5 molar equivalents, or about 0.1 molar equivalents to about 1 molar equivalents.

Embodiment 12 is the composition of any one of embodiments 1-11, wherein the solvent comprises water.

Embodiment 13 is the composition of any one of embodiments 1-12, wherein the coating mixture is present in an amount in a range of about 1 g/L to about 150 g/L, or about 10 g/L to about 100 g/L, or about 25 g/L to about 75 g/L, or about 40 g/L to about 60 g/L, or about 45 g/L to about 55 g/L.

Embodiment 14 is the composition of any one of embodiments 1-13, wherein each of the one or more monoglycerides comprises a carbon chain length of about C10 to about C22.

Embodiment 15 is the composition of any one of embodiments 1-14, wherein each of the one or more monoglycerides comprises a carbon chain length selected from the group of: C10, C12, C14, C16, C18, C20, or C22.

Embodiment 16 is the composition of any one of embodiments 1-15, wherein at least one of the one or more monoglycerides comprises a carbon chain length of C18.

Embodiment 17 is the composition of any one of embodiments 1-16, wherein one of the monoglycerides is glyceryl monostearate.

Embodiment 18 is the composition of any one of embodiments 1-17, wherein each of the one or more fatty acid salts comprises a carbon chain length of about C10 to about C20.

Embodiment 19 is the composition of any one of embodiments 1-18, wherein each of the one or more fatty acid salts comprises a carbon chain length selected from the group of: C10, C12, C14, C16, C18, or C20.

Embodiment 20 is the composition of any one of embodiment 1-19, wherein at least one of the one or more fatty acid salts comprises a carbon chain length of C18.

Embodiment 21 is the composition of any one of embodiments 1-20, wherein one of the fatty acid salts is sodium stearate.

Embodiment 22 is the composition of any one of embodiments 1-21, wherein the viscosity of the edible coating composition is in a range of about 1.7 cP to about 15 cP at a temperature of about 20° C. over shear rates from 15 to 1000 l/s.

Embodiment 23 is the composition of any one of embodiments 1-22, wherein the composition is coated onto an agricultural product.

Embodiment 24 is the composition of embodiment 23, wherein the agricultural product has a mass loss factor of at least 1.50, at least 1.6, at least 1.7, at least 1.8.

Embodiment 25 is an agricultural product having a coating thereover, wherein the coating is formed from the edible coating composition of any one of embodiments 1-24.

Embodiment 26 is the agricultural product of embodiment 25, wherein the agricultural product has a mass loss factor of at least 1.50, at least 1.6, at least 1.7, at least 1.8, or at least 2.

Embodiment 27 is a method of preparing an edible coating composition, the method comprising:
combining a solvent and a base in a reservoir to yield a first mixture; and
combining the first mixture and a coating mixture to yield the edible coating composition;
   wherein the coating mixture comprises:
   about 75 wt % to about 98 wt % of one or more monoglycerides;
   about 1 wt % to about 5 wt % of one or more fatty acid salts; and
   about 1 wt % to about 20 wt % of one or more of lecithin, an ammonium phosphatide, and lysolecithin.

Embodiment 28 is the method of embodiment 27, wherein combining the first mixture and the coating mixture comprises blending the first mixture and the coating mixture.

Embodiment 29 is the method of embodiment 28, wherein combining the first mixture and the coating mixture comprises homogenizing first mixture and the coating mixture.

Embodiment 30 is the method of any one of embodiments 27-29, wherein the coating mixture and the first mixture are combined for about 1 minute to about 2 hours, or about 1 minute to 1 hour, or about 1 minute to 30 minutes, or about 10 minutes to about 30 minutes.

Embodiment 31 is the method of any one of embodiments 27-30, wherein the solvent comprises water.

Embodiment 32 is the method of any one of embodiments 27-31, wherein the first mixture is heated to a temperature of about 40° C. to about 100° C. or about 50° C. to about 70° C.

Embodiment 33 is the method of any one of embodiments 27-32, wherein the coating mixture comprises lecithin.

Embodiment 34 is the method of any one of embodiments 27-33, wherein the lecithin is de-oiled.

Embodiment 35 is the method of any one of embodiments 27-34, wherein the one or more of lecithin, the ammonium phosphatide, and lysolecithin is present in the coating mixture in an amount in a range of about 1 wt % to about 15 wt %, or about 1 wt % to about 12 wt %, 2 wt % to about 8 wt %, or about 3 wt % to about 7 wt %, or about 5 wt %.

Embodiment 36 is the method of any one of embodiments 27-35, wherein the coating mixture comprises ammonium phosphatide.

Embodiment 37 is the method of any one of embodiments 27-36, wherein the coating mixture comprises lysolecithin.

Embodiment 38 is the method of any one of embodiments 27-37, wherein the one or more monoglycerides is present in the coating mixture in an amount of about 80 wt % to about 98 wt %, or 85 wt % to about 98 wt %, or about 90 wt % to about 98 wt %, or about 92 wt % to about 97 wt %, or about 95 wt %.

Embodiment 39 is the method of any one of embodiments 27-38, wherein the base comprises one or more of NaOH, LiOH, KOH, K₂CO₃, Na₂CO₃, Li₂CO₃, KHCO₃, LiHCO₃, and NaHCO₃.

Embodiment 40 is the method of embodiment 39, wherein the base comprises one or more of NaOH, Na₂CO₃, and NaHCO₃.

Embodiment 41 is the method of embodiment 40, wherein the base comprises NaOH.

Embodiment 42 is the method of any one of embodiments 27-41, wherein the base is present in an amount in a range of about 0.01 molar equivalents to about 2 molar equivalents relative to the total molar amount of one or more of lecithin, ammonium phosphatide, and lysolecithin, or about 0.1 molar equivalents to about 1.5 molar equivalents, or about 0.1 molar equivalents to about 1 molar equivalents.

Embodiment 43 is the method of any one of embodiments 27-42, wherein the solvent comprises water.

Embodiment 44 is the method of any one of embodiments 27-43, wherein the coating mixture is present in edible coating composition in an amount in a range of about 1 g/L to about 150 g/L, or about 10 g/L to about 100 g/L, or about 25 g/L to about 75 g/L, or about 40 g/L to about 60 g/L, or about 45 g/L to about 55 g/L.

Embodiment 45 is the method of any one of embodiments 27-44, wherein each of the one or more monoglycerides comprises a carbon chain length of about C10 to about C22.

Embodiment 46 is the method of any one of embodiments 27-45, wherein each of the one or more monoglycerides comprises a carbon chain length selected from the group of: C10, C12, C14, C16, C18, C20, or C22.

Embodiment 47 is the method of any one of embodiments 27-46, wherein at least one of the one or more monoglycerides comprises a carbon chain length of C18.

Embodiment 48 is the method of any one of embodiments 27-47, wherein one of the monoglycerides is glyceryl monostearate.

Embodiment 49 is the method of any one of claims 27-48, wherein each of the one or more fatty acid salts comprises a carbon chain length of about C10 to about C20.

Embodiment 50 is the method of any one of embodiments 27-49, wherein each of the one or more fatty acid salts comprises a carbon chain length selected from the group of: C10, C12, C14, C16, C18, or C20.

Embodiment 51 is the method of any one of embodiments 27-50, wherein at least one of the one or more fatty acid salts comprises a carbon chain length of C18.

Embodiment 52 is the method of any one of embodiments 27-51, wherein one of the fatty acid salts is sodium stearate.

Embodiment 53 is the method of any one of embodiments 27-52, wherein the viscosity of the edible coating composition is in a range of about 1.7 to about 15 cP at a temperature of about 20° C. over shear rates from 15 to 1000 l/s.

Embodiment 54 is the method of any one of embodiments 27-53, further comprising coating the edible coating composition onto an agricultural product.

Embodiment 55 is the method of embodiment 54, wherein coating the edible coating composition onto an agricultural product comprises dip-coating.

Embodiment 56 is the method of embodiment 54 or 55, wherein the agricultural product has a mass loss factor of at least 1.50, at least 1.6, at least 1.7, at least 1.8.

Embodiment 57 is a method of coating an agricultural product, the method comprising:
applying the edible coating composition of any one of embodiments 1-24 to a surface of an agricultural product; and
drying the edible coating composition on the surface of the agricultural product.

Embodiment 58 is an edible coating composition for coating an agricultural product, wherein the edible coating composition is prepared according to the method of any one of embodiments 27-56.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. An edible coating composition comprising:
a coating mixture comprising:
about 75 wt % to about 98 wt % of one or more monoglycerides;
about 1 wt % to about 5 wt % of one or more fatty acid salts; and
about 1 wt % to about 20 wt % of one or more of lecithin, an ammonium phosphatide, and lysolecithin;
a base; and
a solvent.

2. The composition of claim 1, wherein the coating mixture comprises lecithin.

3. The composition of claim 1, wherein the lecithin is de-oiled.

4. The composition of claim 1, wherein the one or more of lecithin, the ammonium phosphatide, and lysolecithin is present in the coating mixture in an amount in a range of about 1 wt % to about 15 wt %.

5. The composition of claim 1, wherein the coating mixture comprises ammonium phosphatide.

6. The composition of any one of claim 1, wherein the coating mixture comprises lysolecithin.

7. The composition of claim 1, wherein the one or more monoglycerides is present in the coating mixture in an amount of about 80 wt % to about 98 wt %.

8. The composition of claim 1, wherein the base comprises one or more of NaOH, LiOH, KOH, K₂CO₃, Na₂CO₃, Li₂CO₃, KHCO₃, LiHCO₃, and NaHCO₃.

9. The composition of claim 1, wherein the base is present in an amount in a range of about 0.01 molar equivalents to about 2 molar equivalents relative to the total molar amount of one or more of lecithin, ammonium phosphatide, and lysolecithin.

10. The composition of claim 1, wherein the solvent comprises water.

11. The composition of claim 1, wherein the coating mixture is present in an amount in a range of about 1 g/L to about 150 g/L.

12. The composition of claim 1, wherein each of the one or more monoglycerides comprises a carbon chain length of about C10 to about C22.

13. The composition of claim 1, wherein one of the monoglycerides is glyceryl monostearate.

14. The composition of claim 1, wherein each of the one or more fatty acid salts comprises a carbon chain length of about C10 to about C20.

15. The composition of claim 1, wherein each of the one or more fatty acid salts comprises a carbon chain length selected from the group of: C10, C12, C14, C16, C18, or C20.

16. The composition of claim 1, wherein at least one of the one or more fatty acid salts comprises a carbon chain length of C18.

17. The composition of claim 1, wherein one of the fatty acid salts is sodium stearate.

18. The composition of claim 1, wherein the viscosity of the edible coating composition is in a range of about 1.7 cP to about 15 cP at a temperature of about 20° C. over shear rates from 15 to 1000 l/s.

19. An agricultural product having a coating thereover, wherein the coating is formed from the edible coating composition of claim 1.

20. The agricultural product of claim 25, wherein the agricultural product has a mass loss factor of at least 1.50.

21. A method of preparing an edible coating composition, the method comprising:
combining a solvent and a base in a reservoir to yield a first mixture; and
combining the first mixture and a coating mixture to yield the edible coating composition;
wherein the coating mixture comprises:
about 75 wt % to about 98 wt % of one or more monoglycerides;
about 1 wt % to about 5 wt % of one or more fatty acid salts; and
about 1 wt % to about 20 wt % of one or more of lecithin, an ammonium phosphatide, and lysolecithin.

22. A method of coating an agricultural product, the method comprising:
applying the edible coating composition of claim 1 to a surface of an agricultural product; and
drying the edible coating composition on the surface of the agricultural product.
